(19) United States
(12) Patent Application Publication
(10) Pub. No.: US 2015/0155930 A1
(43) Pub. Date: Jun. 4, 2015

(54) Method and Relay Node for Implementing Multiple Wireless Backhauls

(71) Applicant: Telefonaktiebolaget L M Ericsson (publ), Stockholm (SE)

(72) Inventors: Jinhua Liu, Beijing (CN); Rui Fan, Beijing (CN); Xinyu Gu, Beijing (CN)

(73) Assignee: TELEFONAKTIEBOLAGET L M ERICSSON (PUBL), Stockholm (SE)

(21) Appl. No.: 14/411,001

(22) PCT Filed: Jun. 29, 2012
(86) PCT No.: PCT/CN2012/000895

§ 371 Date: Dec. 23, 2014

(51) Int. Cl. H04B 7/155; H04W 24/08; H04W 28/08; H04W 28/02

(52) U.S. Cl. CPC H04B 7/15557; H04W 28/0215; H04W 24/08; H04W 28/085

(57) ABSTRACT

The embodiments disclose a method and a relay node for adjusting relay capacity in a wireless communication network which includes the relay node and a plurality of communication nodes. The relay node communicates with a first communication node of the plurality of communication nodes via a first wireless backhaul link established via a first type of interface The method comprise determining that there is a traffic congestion on the first wireless backhaul link, and establishing a second wireless backhaul link between the relay node and a second communication node of the plurality of communication nodes based on UE access procedure via a second type of interface.

### TECHNICAL FIELD

The present technology generally relates to wireless communication, particularly to a method and relay node for implementing multiple wireless backhauls in a wireless communication network.

### BACKGROUND

Currently, wireless communication networks such as 3^{rd} Generation Partner Project (3GPP) Long Term Evolution (LTE) have been widely deployed to provide high speed data services. It may be expected that the mobile wideband traffic will increase dramatically, which raises higher demand on coverage and capacity of the system.

Relaying is a feature in 3GPP LTE Release 10 to improve coverage and cell-edge throughput. The 3GPP architecture defines a new node type called Relay Node (RN). RNs may be used to extend the coverage of cellular networks. Apart from this, RNs could also help in the enhancing of the capacity in hotspots and increasing the effective cell throughput. An overview of the relay support in LTE Release 10 is described in 3GPP TS 36.300.

FIG. 1 shows a schematic view of a LTE network architecture that supports relaying. As shown in FIG. 1, the relaying functions are implemented in a RN 110. The RN 110 appears to a User Equipment (UE) 101 as a normal evolved NodeB (eNB) and schedules the uplink and downlink transmission on the Uu interface. The RN 110 is connected to an eNB 120 via Un air interface. The eNB 120 is called Donor eNB (DeNB), which is otherwise a normal eNB such as eNB 130 that may serve UEs of its own. There is a X2 interface between the DeNB 120 and the RN 110 which supports handovers between the RN and any other eNB. A S1 interface between the DeNB 120 and the RN 110 allows the RN 110 to communicate via DeNB with a serving gateway (S-GW) and Mobility Management Entity (MME) which is a part of Evolved Packet Core (EPC) 140. Finally, a S11 interface allows the MME to configure the S1 tunnelling functions inside the DeNB 120.

According to the current architecture, one RN is only served by one DeNB, and the RN needs to share the radio resources in the Un interface with the UEs served by the DeNB. The capacity of the backhaul link between the RN and its DeNB is limited and may become a bottleneck in practice, especially in case of heavy traffic load in the DeNB and/or poor radio link condition between the RN and the DeNB.

The concept of multiple-backhaul relay has been proposed to alleviate the bottleneck. For instance, the concept of multiple-backhaul relay is described by Min Lee, Seong Keun Oh in “A multi-link relay station and a fast inter-cell handover procedure”, Workshops Proceedings of the Global Communications Conference, GLOBECOM 2011, 5-9 Dec. 2011, Houston, Tex., USA. IEEE 2011, ISBN 978-1-4673-0039-1. However, the description is only conceptual and does not give clear or concrete description on how to implement a multiple independent backhaul link RN and how multiple eNBs serving the same RN work. Another document, IEEE P802.16n™/D1, “Air Interface for Broadband Wireless Access Systems Draft Amendment: Higher Reliability Networks”, describes that one multiple-backhaul-link RN may connect to multiple eNBs or connect with one eNB. For either solution, additional coordination signaling and routing functionalities should be introduced in the eNB in order for in-sequence data delivery, i.e, the eNB has to be modified to support such a multiple backhaul link deployment. Such multiple-backhaul links also have difficulties in deployment between different types of eNBs.

### SUMMARY

Therefore, it is an object to solve at least one of the above-mentioned problems.

According to an aspect of the embodiments, a method in a RN for adjusting relay capacity in a wireless communication network which includes the RN and a plurality of communication nodes is provided. The RN communicates with a first communication node of the plurality of communication nodes via a first wireless backhaul link established via a first type of interface. The method comprises determining that there is a traffic congestion on the first wireless backhaul link, and establishing a second wireless backhaul link between the RN and a second communication node of the plurality of communication nodes based on UE access procedure via a second type of interface.

According to another aspect of the embodiments, a RN in a wireless communication network which includes a plurality of communication nodes is provided. The RN comprises a first type of interface, a second type of interface and a controlling unit. The first type of interface is figured to establish a first wireless backhaul link with a first communication node of the plurality of communication nodes. The controlling unit is configured to determine that there is a traffic congestion on the first wireless backhaul link; and control the second type of interface to establish a second wireless backhaul link with a second communication node of the plurality of communication nodes based on UE access procedure.

The embodiments of the invention allows a RN to setup more than one wireless backhaul links with communication nodes such as eNBsin a wireless communication network to improve total backhaul link capacity and the load sharing among communication nodes, without making modifications to the existing communication nodes.

### BRIEF DESCRIPTION OF THE DRAWINGS

The technology will be described in detail by reference to the following drawings, in which:

FIG. 1 shows a schematic view of a LTE network architecture that supports relaying;

FIG. 2 shows a schematic view of a wireless communication network 200 employing multiple-backhaul relaying in accordance with an embodiment;

FIG. 3 shows a flowchart of a method 300 in a RN for adjusting relay backhaul capacity in a wireless communication network in accordance with an embodiment; and

FIG. 4 shows a block diagram of a RN 400 in a wireless communication network which includes a plurality of communication node in accordance with an embodiment.

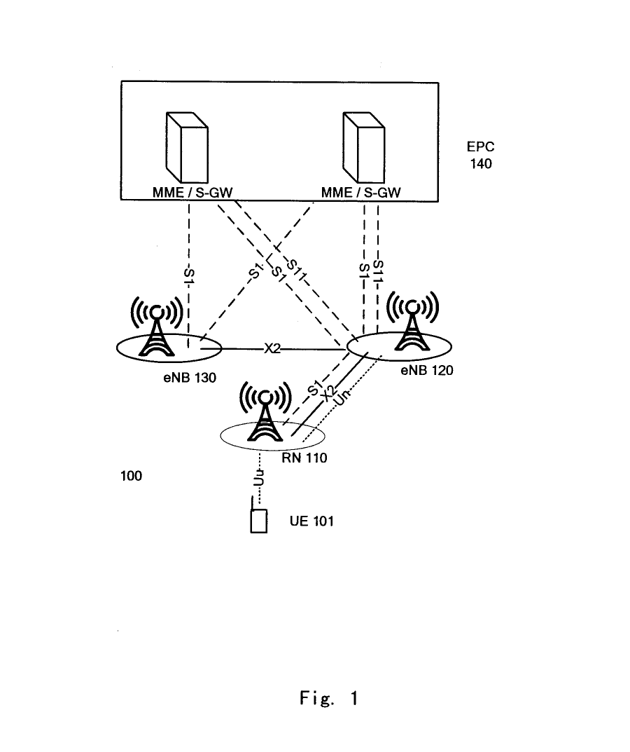

### DETAILED DESCRIPTION

Embodiments herein will be described more fully hereinafter with reference to the accompanying drawings, in which embodiments are shown. This embodiments herein may, however, be embodied in many different forms and should not be construed as limited to the embodiments set forth herein. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

The present technology is described below with reference to block diagrams and/or flowchart illustrations of methods, apparatus (systems) and/or computer program products according to the present embodiments. It is understood that blocks of the block diagrams and/or flowchart illustrations, and combinations of blocks in the block diagrams and/or flowchart illustrations, may be implemented by computer program instructions. These computer program instructions may be provided to a processor, controller or controlling unit of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Accordingly, the present technology may be embodied in hardware and/or in software (including firmware, resident software, micro-code, etc.). Furthermore, the present technology may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that may contain, store, communicate, propagate, or transport the program for use by or in connection with the instruction execution system, apparatus, or device.

Although the technology herein is described with reference to the LTE communication network in the context, it should understand that the embodiments are not limited to this, but may indeed be applied to all wireless communication networks that need relay. Although specific terms in some specifications are used here, such as eNB, RN and EPC, it should be understand that the embodiments are not limited to those specific terms but may be applied to all similar entities, such as macro base station, femto base stations and Core Network (CN). The term “communication node” used herein may indicate any type of communication node, such as eNB, NodeB and so on.

Embodiments herein will be described below with reference to the drawings.

In practice, the RN is deployed at cell border or shadow area to improve coverage. Usually, there are neighboring cells around the RN and the path-loss difference between these neighboring cells and the RN is relatively small. According to an aspect of the present disclosure, if the current wireless backhaul between the RN and eNB has congestion, the RN may establish additional wireless backhaul(s) with neighboring eNB(s) to make use of the available radio resource in neighboring cell(s).

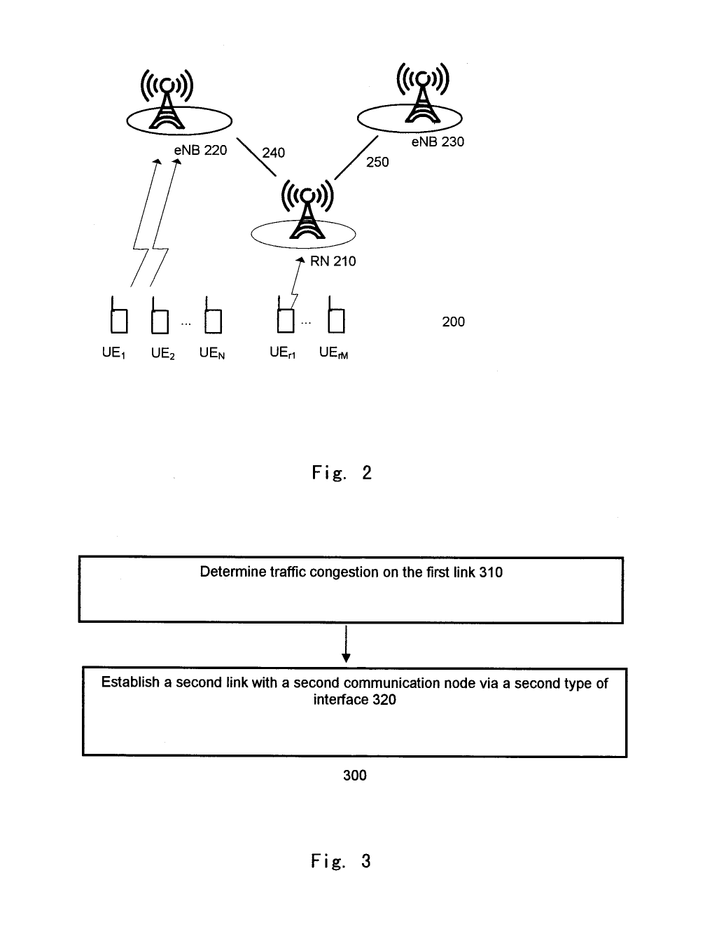

FIG. 2 shows a schematic view of a wireless communication network 200 employing multiple-backhaul relaying in accordance with an embodiment.

As shown in FIG. 2, the wireless communication network 200 comprises two eNBs 220 and 230. The eNB 220 serves multiple UEs, UE₁ to UE_{M}, e.g. via Uu interface. A RN 210 is deployed, e.g. in an indoor environment to serve one or more UEs, UEᵣ₁ to UE_{rN}. The RN 210 is connected to the eNB 220 by an established wireless backhaul link 240, e.g. via Un interface. If a traffic congestion on the backhaul link 240 is determined, the RN 210 may establish another wireless backhaul link 250 with the neighbouring eNB 230 to improve the relay backhaul capacity. In an embodiment, when the RN 210 needs to establish the wireless backhaul link 250, the RN 210 may construct a virtual UE module with predefined configurations. Such predefined configurations include: the usable radio access technologies and carrier frequencies, the UE category such as the maximum uplink and downlink throughput supported by the UE, related protocols, the information that is carried by a corresponding SIM card, such as the International Mobile Equipment Identity (IMEI) number, etc. According to the predefined configurations, the functionalities of the virtual UE module are created, which include the transmitter and receiver, the transmitting (TX) and receiving (RX) buffers, protocol functionalities, etc. The functionality of the virtual UE is equivalent to a normal UE of the same category from the eNB perspective. Then the RN 210 may trigger the virtual UE module to set up a radio connection to the preferred target eNB using a UE access procedure. From the perspective of the eNB 230, the RN 210 is no different from a UE since the corresponding virtual UE module looks like a normal full-functional UE. After establishing a second wireless backhaul link, an ongoing session served by the RN 210 over the first backhaul link may be switched to the second backhaul link and a new session set up by a UE served by the RN 210 may be assigned on the second wireless backhaul link 250 instead of the first wireless backhaul link 240 when the first backhaul link is in congestion.

FIG. 3 shows a flowchart of a method 300 in a RN for adjusting relay backhaul capacity in a wireless communication network in accordance with an embodiment.

The wireless communication network includes the RN such as RN 210 and a plurality of communication nodes such as eNBs 230 and 270. The RN may communicate with a first communication node of the plurality of communication nodes via a first wireless backhaul link established via a first type of interface. The first type of interface may be, for instance, the special Un interface for relay backhaul setup or a Uu interface for a service link setup of a normal UE or other suitable interface for establishing backhaul link. At step 310, it is determined that there is a traffic congestion on the first wireless backhaul link. At step 320, a second wireless backhaul link between the RN and a second communication node of the plurality of communication nodes is established based on UE access procedure via a second type of interface. The second type of interface is e.g. LTE based Uu interface or WCDMA based Uu interface, or WIFI radio interface, etc. For instance, the second type of interface may be implemented by a constructed virtual UE module in the RN. The constructed virtual UE module logically implements all the necessary protocols for the UE but it is not a physically stand-alone device. The virtual UE module operates as a full functional UE from the network perspective, which means that once the virtual UE module activate a second backhaul setup (i.e., service link) to the second communication node, the second communication node treats the virtual UE module as a normal UE.

The UE access procedure varies among networks. Below a UE access procedure in a LTE network will be briefly introduced. When the UE is powered on, the UE starts to search synchronization signals based on the supportable radio access technologies. Once synchronization is established between the UE and the network, the UE may start to measure signal strengths from different cells. According to preconfigured rules, the UE may camp on a cell with an acceptable signal strength. The preconfigured rules may include one or more of the preferred radio access technology, the preferred carrier frequency, the preferred operator, etc. Then the UE starts to monitor the broadcasted system information blocks to get the required information on the network configurations to be prepared for the possible service link setup either activated from the network side or from the UE side. When the UE starts to access the network, it sends a randomly selected random access preamble to the cell. After receiving the preamble from the UE, the cell sends a response to inform the UE that the preamble is received, and the UE then sends more information to the network such as the service characteristics and the UE characteristics. Then the network may accept or reject the UE according to traffic load situation and traffic handling priority requested by the UE.

Once the second wireless backhaul link is established, traffic of a UE newly accessed via the RN may be assigned on the second wireless backhaul link. The first wireless backhaul link and the second wireless backhaul link may be divided in at least one of space, time, spreading code and frequency domain, depending on the particular network type and configurations. For example, the interference between different wireless backhaul links may be reduced by means of beamforming, time division or frequency division transmission.

The RN may monitor traffic information and determine that there is a traffic congestion on the first wireless backhaul link based on the monitored traffic information. The traffic information may include at least one of buffer status of the RN, transmission delay on the first wireless backhaul link, overall data rate on access links between the RN and one or more UEs served by the RN and overall data rate on the first wireless backhaul link. For example, if the uplink TX buffer of the RN has a high utilization ratio, or the uplink transmission delay on the first wireless backhaul link is high, a traffic congestion on the first wireless backhaul link in uplink may be determined. High overall data rate on access links between the RN and one or more UEs served by the RN or high overall data rate on the first wireless backhaul link also indicates a traffic congestion. To improve the accuracy of determination, the traffic information may be monitored over a certain period. In another embodiment, the RN may send a request message to the first communication node for requesting a data rate on the first backhaul link. Upon receiving a response message from the first communication node indicating a data rate granted on the first backhaul link, the RN may determine that there is a traffic congestion on the first wireless backhaul link when the granted data rate is lower than the requested data rate or when the granted data rate does not exceed a threshold.

When establishing the second wireless backhaul link, the RN may select a communication node with high signal quality as the second communication node. For example, the RN may measure reference signal powers of the plurality of the communication nodes, and establishing the second wireless backhaul link between the RN and the second communication node with highest measured reference signal power. When there is no traffic congestion on the first wireless backhaul link, e.g. the traffic information indicates that the load on the first wireless backhaul link returns to normal condition, the second wireless backhaul link may be released.

If the RN determines that there are traffic congestions on both the first wireless backhaul link and the second wireless backhaul link, it may establish an additional wireless backhaul link between the RN and an additional communication node of the plurality of communication nodes via the first type of interface or the second type of interface. That is, even more backhauls may be established for load balancing.

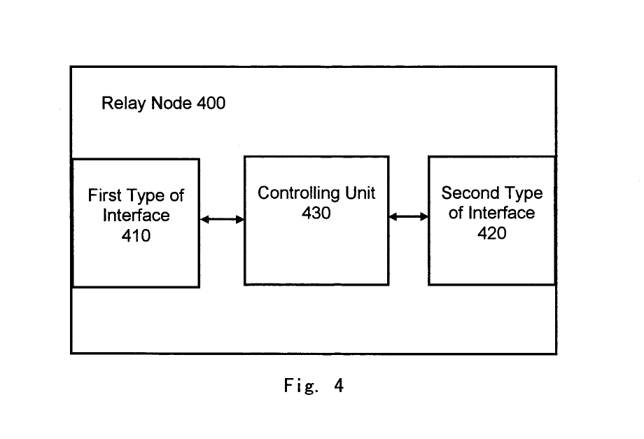

FIG. 4 shows a block diagram of a RN 400 in a wireless communication network, the wireless communication network also includes a plurality of communication nodes in accordance with an embodiment.

As shown in FIG. 4, the RN 400 comprises a first type of interface 410, a second type of interface 420 and a controlling unit 430. The first type of interface 410 is configured to establish a first wireless backhaul link with a first communication node of a plurality of communication nodes. The controlling unit 430 may implemented by e.g. a processor. The controlling unit 430 is configured to determine that there is a traffic congestion on the first wireless backhaul link, and control the second type of interface 420 by e.g. sending a signalling message, to establish a second wireless backhaul link with a second communication node of the plurality of communication nodes based on UE access procedure. The controlling unit 430 may monitor traffic information, and determine the traffic congestion on the first wireless backhaul link based on the monitored traffic information. The controlling unit 430 may send a request message to the first communication node for requesting a data rate on the first backhaul link, receive a response message from the first communication node indicating a data rate granted on the first backhaul link, and determine that there is a traffic congestion on the first wireless backhaul link when the granted data rate is lower than the requested data rate or does not exceed a threshold. The controlling unit 430 may measure reference signal powers of the plurality of the communication nodes, and control the second type of interface to establish the second wireless backhaul link between the RN and the second communication node with highest measured reference signal power. The controlling unit 430 may control the second type of interface 420 to release the second wireless backhaul link when there is no traffic congestion on the first wireless backhaul link. The controlling unit 430 may assign traffic of a new accessed UE onto the second wireless backhaul link. The controlling unit 430 may determine that there are traffic congestions on the first wireless backhaul link and the second wireless backhaul link, and establish an additional wireless backhaul link between the RN and an additional communication node of the plurality of communication nodes via the first type of interface 420 or the second type of interface 430.

By establishing supplementary wireless backhaul link(s) with other communication node(s) based on UE access procedure, the backhaul capacity of the RN is improved and dynamically adjusted while no modifications need to be made to the existing communication nodes. In addition, since the UE access procedure exists in all wireless communication networks, the multiple-backhaul solution in the present disclosure may be applied to any type of communication networks instead of being limited to LTE network, and the RN may even establish an additional wireless backhaul link with a communication node which has a different type than the currently connected communication node. Moreover, the RN may be easily implemented, e.g. by adding one or more radio modules, commonly used in UEs, to the RN.

As a variation of the embodiment, the establishment of the additional wireless backhaul link may be triggered by the communication node instead of the RN. In this case, the traffic information on the existing wireless backhaul link may be either monitored by the communication node itself or reported to the communication node by the RN. The communication node may specify another communication node with which the additional wireless backhaul link is to be established. In this embodiment, the requirements for the RN, e.g. the required processing power, are lowered. However, the specification of communication node needs to be modified in this embodiment.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore it is intended that the present embodiments not be limited to the particular embodiment disclosed as the best mode contemplated for carrying out the present technology, but that the present embodiments include all embodiments falling within the scope of the appended claims.

1-18. (canceled)

19. A method, in a relay node, for adjusting relay capacity in a wireless communication network that includes the relay node and a plurality of communication nodes, the relay node being configured to communicate with a first communication node of the plurality of communication nodes via a first wireless backhaul link established via a first type of interface, the method comprising:
determining whether there is traffic congestion on the first wireless backhaul link; and
responsive to a determination that there is traffic congestion on the first wireless backhaul link, establishing a second wireless backhaul link between the relay node and a second communication node of the plurality of communication nodes based on a User Equipment, UE, access procedure via a second type of interface.

20. The method of claim 19, wherein said determining comprises:
monitoring traffic information; and
determining that there is traffic congestion on the first wireless backhaul link based on the monitored traffic information.

21. The method of claim 20, wherein the traffic information includes at least one of buffer status of the relay node, transmission delay on the first wireless backhaul link, overall data rate on access links between the relay node and one or more UEs served by the relay node and overall data rate on the first wireless backhaul link.

22. The method of claim 19, wherein said determining comprises:
sending a request message to the first communication node for requesting a data rate on the first backhaul link;
receiving a response message from the first communication node indicating a data rate granted on the first backhaul link; and
determining that there is a traffic congestion on the first wireless backhaul link when the granted data rate is lower than the requested data rate or does not exceed a threshold.

23. The method of claim 19, wherein said establishing comprises:
measuring reference signal powers of the plurality of the communication nodes; and
establishing the second wireless backhaul link between the relay node and the second communication node with a highest measured reference signal power.

24. The method of claim 19, further comprising:
releasing the second wireless backhaul link when there is no traffic congestion on the first wireless backhaul link.

25. The method of claim 19, further comprising:
assigning traffic of a new accessed UE to the second wireless backhaul link.

26. The method of claim 19, wherein the first wireless backhaul link and the second wireless backhaul link are divided in at least one of space, time, spreading code and frequency domain.

27. The method of claim 19, further comprising
determining whether there is traffic congestion on both the first wireless backhaul link and the second wireless backhaul link; and
responsive to a determination that there is traffic congestion on both the first wireless backhaul link and the second wireless backhaul link, establishing an additional wireless backhaul link between the relay node and an additional communication node of the plurality of communication nodes via the first type of interface or the second type of interface.

28. A relay node in a wireless communication network that includes a plurality of communication nodes, the relay node comprising:
a first type of interface configured to establish a first wireless backhaul link with a first communication node of the plurality of communication nodes;
a second type of interface; and
processing circuitry configured to:
determine whether there is traffic congestion on the first wireless backhaul link; and
responsive to a determination that there is traffic congestion on the first wireless backhaul link, control the second type of interface to establish a second wireless backhaul link with a second communication node of the plurality of communication nodes based on a User Equipment, UE, access procedure.

29. The relay node of claim 28, wherein the processing circuitry is configured to determine whether there is congestion based on being configured to:
monitor traffic information; and
determine that there is traffic congestion on the first wireless backhaul link based on the monitored traffic information.

30. The relay node of claim 29, wherein the traffic information includes at least one of buffer status of the relay node, transmission delay on the first wireless backhaul link, overall data rate on access links between the relay node and one or more UEs served by the relay node and overall data rate on the first wireless backhaul link.

31. The relay node of claim 28, wherein the processing circuitry is configured to:
send a request message to the first communication node for requesting a data rate on the first backhaul link;
receive a response message from the first communication node indicating a data rate granted on the first backhaul link; and
determine that there is traffic congestion on the first wireless backhaul link when the granted data rate is lower than the requested data rate or does not exceed a threshold.

32. The relay node of claim 28, wherein the processing circuitry is configured to:
measure reference signal powers of the plurality of the communication nodes; and
control the second type of interface to establish the second wireless backhaul link between the relay node and the second communication node with a highest measured reference signal power.

33. The relay node of claim 28, wherein the processing circuitry is configured to:
control the second type of interface to release the second wireless backhaul link when there is no traffic congestion on the first wireless backhaul link.

34. The relay node of claim 28, wherein the processing circuitry is configured to:
assign traffic of a new accessed UE to the second wireless backhaul link.

35. The relay node of claim 28, wherein the first wireless backhaul link and the second wireless backhaul link are divided in at least one of space, time, spreading code and frequency domain.

36. The relay node of claim 28, wherein the processing circuitry is configured to:
determine whether there is traffic congestion on both the first wireless backhaul link and the second wireless backhaul link; and
responsive to a determination that there is traffic congestion on both the first wireless backhaul link and the second wireless backhaul link, establish an additional wireless backhaul link between the relay node and an additional communication node of the plurality of communication nodes via the first type of interface or the second type of interface.
